(19) United States
(12) Patent Application Publication
(10) Pub. No.: US 2024/0385841 A1
(43) Pub. Date: Nov. 21, 2024

(54) FETCHING BEYOND PREDICTED-TAKEN BRANCH INSTRUCTIONS IN FETCH BUNDLES OF PROCESSOR-BASED DEVICES

(71) Applicant: QUALCOMM Incorporated, San Diego, CA (US)

(72) Inventors: Conrado Blasco, San Mateo, CA (US); Ajay Kumar Rathee, San Jose, CA (US); Huzefa Sanjeliwala, Austin, TX (US)

(21) Appl. No.: 18/594,899

(22) Filed: Mar. 4, 2024

Related U.S. Application Data
(60) Provisional application No. 63/503,053, filed on May 18, 2023.

(51) Int. Cl. G06F 9/38

(52) U.S. Cl. CPC G06F 9/3804; G06F 9/3814

(57) ABSTRACT

Fetching beyond predicted-taken branch instructions in fetch bundles of processor-based devices is disclosed. In exemplary aspects, a processor-based device comprises an instruction processing circuit configured to process an instruction stream in an instruction pipeline. The instruction processing circuit comprises an instruction fetch circuit configured to generate a fetch bundle comprising a plurality of fetched instructions from the instruction stream, wherein a last fetched instruction of the plurality of fetched instructions is a predicted-taken branch instruction. The instruction processing circuit is further configured to identify the plurality of fetched instructions as a loop iteration. The instruction processing circuit is also configured to determine that at least one loop iteration copy fits within the fetch bundle. The instruction processing circuit is additionally configured to, responsive to determining that the at least one loop iteration copy fits within the fetch bundle, store the at least one loop iteration copy within the fetch bundle.

### PRIORITY APPLICATION

The present application claims priority to U.S. Provisional Patent Application Ser. No. 63/503,053, filed on May 18, 2023 and entitled “FETCHING BEYOND PREDICTED-TAKEN BRANCH INSTRUCTIONS IN FETCH BUNDLES OF PROCESSOR-BASED DEVICES,” the contents of which is incorporated herein by reference in its entirety.

### BACKGROUND

### I. Field of the Disclosure

The technology of the disclosure relates generally to instruction fetch circuits in processor-based devices, and, in particular, to making efficient use of fetch buffers.

### II. Background

Conventional processors may employ a processing technique known as instruction pipelining, whereby the throughput of computer instructions being executed may be increased by dividing the processing of each instruction into a series of steps which are then executed within an execution pipeline composed of multiple stages. Optimal processor performance may be achieved if all stages in an execution pipeline are able to process instructions concurrently and sequentially as the instructions are ordered in the execution pipeline. However, the performance of a conventional processor is limited by the fetch performance of the processor's “front end,” which refers generally to the portion of the processor that is responsible for fetching and preparing instructions for execution.

The front-end architecture of the processor may employ a number of different approaches for improving fetch performance. One approach involves using a conditional branch predictor (CBP) to speculatively predict a path to be taken by a branch instruction (based on, e.g., the results of previously executed branch instructions), and basing the fetching of subsequent instructions on the branch prediction. When the branch instruction reaches the execution stage of the processor's instruction pipeline and is executed, the resulting target address of the branch instruction is verified by comparing it with the previously predicted target address when the branch instruction was fetched. If the predicted and actual target addresses match (i.e., the branch prediction was correct), instruction execution can proceed without delay because the subsequent instructions at the target address will have already been fetched and will be present in the instruction pipeline.

To further improve the fetching performance of the processor, an instruction fetch circuit of the processor may use predictions from the CBP to generate a fetch bundle, which comprises a plurality of instructions to be provided to the processor's “back end” (i.e., the portion of the processor that is responsible for executing the instructions and committing changes to the state of the processor) for processing. If the sequence of fetched instructions contains a branch instruction that the CBP predicts will be taken, then the fetch bundle conventionally is terminated at the predicted-taken instruction. This is true regardless of whether the fetch bundle has sufficient available instruction capacity to store additional instructions beyond the predicted-taken instruction. As a consequence, the full potential throughput of the processor may not be realized.

### SUMMARY OF THE DISCLOSURE

Aspects disclosed in the detailed description include fetching beyond predicted-taken branch instructions in fetch bundles of processor-based devices. Related apparatus, methods, and computer-readable media are also disclosed. In this regard, in some exemplary aspects disclosed herein, a processor-based device provides an instruction processing circuit that includes an instruction fetch circuit configured to fetch beyond predicted-taken branch instructions in fetch bundles. The instruction fetch circuit is configured to generate a fetch bundle that comprises a plurality of fetched instructions from an instruction stream, wherein the last fetched instruction of the plurality of fetched instructions is a predicted-taken branch instruction. The instruction fetch circuit identifies the plurality of fetched instructions as a loop iteration (e.g., by determining that a program counter (PC) of the fetch bundle results in a hit in a branch target buffer (BTB) of the instruction processing circuit, and further that a target address of the predicted-taken branch instruction corresponds to the PC of the fetch bundle). The instruction fetch circuit then determines that at least one loop iteration copy fits within the fetch bundle (as a non-limiting example, by determining that a count of the plurality of fetched instructions is equal to or less than half of an instruction capacity of the fetch bundle). If the instruction fetch circuit determines that the at least one loop iteration copy fits within the fetch bundle, the instruction fetch circuit stores the at least one loop iteration copy within the fetch bundle.

Some aspects may provide that, to enable a conditional branch predictor (CBP) of the instruction processing circuit to distinguish between the multiple instances of branch instructions in the fetch bundle, the instruction fetch circuit generates a modified PC for a branch instruction within each loop iteration copy of the at least one loop iteration copy based on an original PC of the branch instruction. For instance, the instruction fetch circuit may generate the modified PC by inverting one or more bits of the original PC of the branch instruction. The instruction fetch circuit subsequently uses the modified PC of the branch instruction to access the CBP (e.g., by using the modified PC of the branch instruction as an index or a tag for a branch prediction structure and/or for the BTB of the CBP). In some aspects, the instruction fetch circuit is also configured to update one or more history registers and/or branch prediction structures of the CBP for each predicted-taken branch instruction within the fetch bundle.

In another aspect, a processor-based device is disclosed. The processor-based device comprises an instruction processing circuit configured to process an instruction stream in an instruction pipeline. The instruction processing circuit comprises an instruction fetch circuit configured to generate a fetch bundle comprising a plurality of fetched instructions from the instruction stream, wherein a last fetched instruction of the plurality of fetched instructions is a predicted-taken branch instruction. The instruction processing circuit is further configured to identify the plurality of fetched instructions as a loop iteration. The instruction processing circuit is also configured to determine that at least one loop iteration copy fits within the fetch bundle. The instruction processing circuit is additionally configured to, responsive to determining that the at least one loop iteration copy fits within the fetch bundle, store the at least one loop iteration copy within the fetch bundle.

In another aspect, a processor-based device is disclosed. The processor-based device comprises means for generating a fetch bundle comprising a plurality of fetched instructions from an instruction stream, wherein a last fetched instruction of the plurality of fetched instructions is a predicted-taken branch instruction. The processor-based device further comprises means for identifying the plurality of fetched instructions as a loop iteration. The processor-based device also comprises means for determining that at least one loop iteration copy fits within the fetch bundle. The processor-based device additionally comprises means for storing the at least one loop iteration copy within the fetch bundle, responsive to determining that the at least one loop iteration copy fits within the fetch bundle.

In another aspect, a method for fetching beyond predicted-taken branch instructions in fetch bundles is disclosed. The method comprises generating, by an instruction fetch circuit of an instruction processing circuit of a processor-based device, a fetch bundle comprising a plurality of fetched instructions from an instruction stream, wherein a last fetched instruction of the plurality of fetched instructions is a predicted-taken branch instruction. The method further comprises identifying, by the instruction fetch circuit, the plurality of fetched instructions as a loop iteration. The method also comprises determining, by the instruction fetch circuit, that at least one loop iteration copy fits within the fetch bundle. The method additionally comprises, responsive to determining that the at least one loop iteration copy fits within the fetch bundle, storing, by the instruction fetch circuit, the at least one loop iteration copy within the fetch bundle.

In another aspect, a non-transitory computer-readable medium is disclosed. The non-transitory computer-readable medium stores computer-executable instructions that, when executed, cause a processor of a processor-based device to generate a fetch bundle comprising a plurality of fetched instructions from an instruction stream, wherein a last fetched instruction of the plurality of fetched instructions is a predicted-taken branch instruction. The computer-executable instructions further cause the processor to identify the plurality of fetched instructions as a loop iteration. The computer-executable instructions also cause the processor to determine that at least one loop iteration copy fits within the fetch bundle. The computer-executable instructions additionally cause the processor to, responsive to determining that the at least one loop iteration copy fits within the fetch bundle, store the at least one loop iteration copy within the fetch bundle.

### BRIEF DESCRIPTION OF THE FIGURES

FIG. 1 is a block diagram of an exemplary processor-based system that includes a processor with an instruction processing circuit that includes an instruction fetch circuit that fetches beyond predicted-taken branch instructions in fetch bundles, according to some aspects;

FIG. 2 is a block diagram illustrating exemplary functionality of the instruction fetch circuit of FIG. 1 for fetching beyond predicted-taken branch instructions in fetch bundles, according to some aspects;

FIGS. 3A-3B provide a flowchart illustrating exemplary operations of the instruction fetch circuit of FIGS. 1 and 2 for fetching beyond predicted-taken branch instructions in fetch bundles, according to some aspects; and

FIG. 4 is a block diagram of an exemplary processor-based device that can include the instruction fetch circuit of FIGS. 1 and 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include fetching beyond predicted-taken branch instructions in fetch bundles of processor-based devices. Related apparatus, methods, and computer-readable media are also disclosed. In this regard, in some exemplary aspects disclosed herein, a processor-based device provides an instruction processing circuit that includes an instruction fetch circuit configured to fetch beyond predicted-taken branch instructions in fetch bundles. The instruction fetch circuit is configured to generate a fetch bundle that comprises a plurality of fetched instructions from an instruction stream, wherein the last fetched instruction of the plurality of fetched instructions is a predicted-taken branch instruction. The instruction fetch circuit identifies the plurality of fetched instructions as a loop iteration (e.g., by determining that a program counter (PC) of the fetch bundle results in a hit in a branch target buffer (BTB) of the instruction processing circuit, and further that a target address of the predicted-taken branch instruction corresponds to the PC of the fetch bundle). The instruction fetch circuit then determines that at least one loop iteration copy fits within the fetch bundle (as a non-limiting example, by determining that a count of the plurality of fetched instructions is equal to or less than half of an instruction capacity of the fetch bundle). If the instruction fetch circuit determines that the at least one loop iteration copy fits within the fetch bundle, the instruction fetch circuit stores the at least one loop iteration copy within the fetch bundle.

Some aspects may provide that, to enable a conditional branch predictor (CBP) of the instruction processing circuit to distinguish between the multiple instances of branch instructions in the fetch bundle, the instruction fetch circuit generates a modified PC for a branch instruction within each loop iteration copy of the at least one loop iteration copy based on an original PC of the branch instruction. For instance, the instruction fetch circuit may generate the modified PC by inverting one or more bits of the original PC of the branch instruction. The instruction fetch circuit subsequently uses the modified PC of the branch instruction to access the CBP (e.g., by using the modified PC of the branch instruction as an index or a tag for a branch prediction structure and/or for the BTB of the CBP). In some aspects, the instruction fetch circuit is also configured to update one or more history registers and/or branch prediction structures of the CBP for each predicted-taken branch instruction within the fetch bundle.

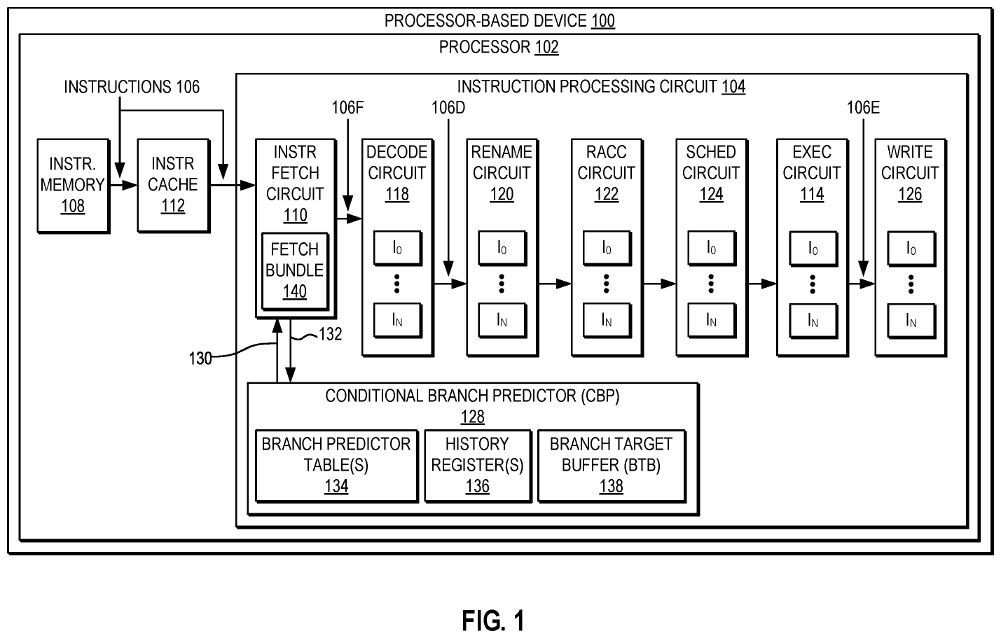

In this regard, FIG. 1 is a diagram of an exemplary processor-based device 100 that includes a processor 102. The processor 102, which also may be referred to as a “processor core” or a “central processing unit (CPU) core,” may be an in-order or an out-of-order processor (OoP), and/or may be one of a plurality of processors 102 provided by the processor-based device 100. In the example of FIG. 1, the processor 102 includes an instruction processing circuit 104 that includes one or more instruction pipelines Io-IN for processing instructions 106 fetched from an instruction memory (captioned “INSTR MEMORY” in FIG. 1) 108 by an instruction fetch circuit (captioned “INSTR FETCH CIRCUIT” in FIG. 1) 110 for execution. The instruction memory 108 may be provided in or as part of a system memory in the processor-based device 100, as a non-limiting example. An instruction cache (captioned “INSTR CACHE” in FIG. 1) 112 may also be provided in the processor 102 to cache the instructions 106 fetched from the instruction memory 108 to reduce latency in the instruction fetch circuit 110.

The instruction fetch circuit 110 in the example of FIG. 1 is configured to provide the instructions 106 as fetched instructions 106F into the one or more instruction pipelines I₀-I_{N} in the instruction processing circuit 104 to be pre-processed, before the fetched instructions 106F reach an execution circuit (captioned “EXEC CIRCUIT” in FIG. 1) 114 to be executed. The instruction pipelines I₀-I_{N} are provided across different processing circuits or stages of the instruction processing circuit 104 to pre-process and process the fetched instructions 106F in a series of steps that can be performed concurrently to increase throughput prior to execution of the fetched instructions 106F by the execution circuit 114.

With continuing reference to FIG. 1, the instruction processing circuit 104 includes a decode circuit 118 configured to decode the fetched instructions 106F fetched by the instruction fetch circuit 110 into decoded instructions 106D to determine the instruction type and actions required. The instruction type and action required encoded in the decoded instruction 106D may also be used to determine in which instruction pipeline I₀-I_{N} the decoded instructions 106D should be placed. In this example, the decoded instructions 106D are placed in one or more of the instruction pipelines I₀-I_{N} and are next provided to a rename circuit 120 in the instruction processing circuit 104. The rename circuit 120 is configured to determine if any register names in the decoded instructions 106D should be renamed to decouple any register dependencies that would prevent parallel or out-of-order processing.

The instruction processing circuit 104 in the processor 102 in FIG. 1 also includes a register access circuit (captioned “RACC CIRCUIT” in FIG. 1) 122. The register access circuit 122 is configured to access a physical register in a physical register file (PRF) (not shown) based on a mapping entry mapped to a logical register in a register mapping table (RMT) (not shown) of a source register operand of a decoded instruction 106D to retrieve a produced value from an executed instruction 106E in the execution circuit 114. The register access circuit 122 is also configured to provide the retrieved produced value from an executed instruction 106E as the source register operand of a decoded instruction 106D to be executed.

Also, in the instruction processing circuit 104, a scheduler circuit (captioned “SCHED CIRCUIT” in FIG. 1) 124 is provided in the instruction pipeline I₀-I_{N} and is configured to store decoded instructions 106D in reservation entries until all source register operands for the decoded instruction 106D are available. The scheduler circuit 124 issues decoded instructions 106D that are ready to be executed to the execution circuit 114. A write circuit 126 is also provided in the instruction processing circuit 104 to write back or commit produced values from executed instructions 106E to memory (such as the PRF), cache memory, or system memory.

With continuing reference to FIG. 1, the instruction processing circuit 104 also includes a conditional branch predictor (CBP) 128. The CBP 128 is a circuit that is configured to speculatively predict the outcome of a fetched branch instruction that controls whether instructions corresponding to a taken path or a not-taken path in the instruction control flow path are fetched into the instruction pipelines I₀-I_{N} for execution. For example, the fetched branch instruction may be a conditional branch instruction 130 among the instructions 106 that includes a condition to be resolved by the instruction processing circuit 104 to determine which instruction control flow path should be taken. In this manner, the outcome of the conditional branch instruction 130 in this example does not have to be resolved in execution by the execution circuit 114 before the instruction processing circuit 104 can continue processing fetched instructions 106F. The prediction made by the CBP 128 can be provided as a branch prediction 132 to the instruction fetch circuit 110 to be used to determine the next instructions 106 to fetch as the fetched instructions 106F.

The CBP 128 generates branch predictions such as the branch prediction 132 using one or more branch predictor tables 134. Each of the one or more branch predictor tables 134 stores a plurality of counters (not shown) that comprise indexable entries (e.g., indexed by a hash of a program counter of a conditional branch instruction, a branch history, and/or a path history) comprising saturated counters that each represent a branch prediction as a signed value. The CBP 128 is configured to speculatively predict the outcome of a conditional branch instruction such as the conditional branch instruction 130 by retrieving a counter from each of multiple ones of the branch predictor tables 134, and then summing the retrieved counters, with the sign of the sum of the counters indicating the branch prediction 132. After the conditional branch instruction 130 is executed by the execution circuit 114, the results of execution of the conditional branch instruction 130 may be used to update the counters corresponding to the branch prediction 132 according to a training algorithm. In conventional branch prediction, the counters are incremented if the branch prediction 132 is correct, and otherwise are decremented. In this manner, the counters over time should better represent the likely branch path of the conditional branch instruction 130 during subsequent executions of the series of instructions that include the conditional branch instruction 130.

To facilitate branch prediction by the CBP 128, the one or more branch predictor tables 134 in the example of FIG. 1 are associated with corresponding one or more history registers 136. The history registers 136 are used to capture previously observed program behavior with respect to previously encountered branches, such as global branch history, path history, and the like. The CBP 128 may then correlate branch behavior with the contents of the history registers 136 when making a branch prediction. The CBP 128 also provides a BTB 138 to cache additional metadata for use in conjunction with the CBP 128 when determining a next fetch address. The BTB comprises a plurality of entries (not shown), each of which corresponds to an aligned memory block from which instructions are fetched, and each of which stores branch metadata relating to branch instructions within that aligned memory block. The branch metadata may include, as non-limiting examples, a branch offset indicating a position of the branch instruction relative to the address of the aligned memory block, a type of branch instruction (e.g., conditional, call, indirect, and the like), and a target address of the branch instruction.

During the process of fetching instructions, the instruction fetch circuit 110 may use an address of an instruction among the instructions 106 to access both the BTB 138 and the CBP 128, and generate a fetch bundle 140 comprising a plurality of instructions (not shown) for processing. The use of the fetch bundle 140 may better enable the instruction fetch circuit 110 to provide instructions to subsequent stages of the instruction processing circuit at a pace sufficient to maximize the throughput of the instruction processing circuit 104 and minimize wasted processor cycles. However, if the sequence of fetched instructions 106F within a conventional fetch bundle contains a branch instruction that the CBP 128 predicts will be taken, then such conventional fetch bundles are terminated at the predicted-taken instruction. This is true regardless of whether the conventional fetch bundle has sufficient available instruction capacity to store additional instructions beyond the predicted-taken instruction.

In this regard, the instruction fetch circuit 110 of FIG. 1 is configured to optimize the use of the instruction capacity of the fetch bundle 140 in circumstances in which the fetch bundle 140 contains instructions corresponding to one iteration of a loop in the instructions 106. As used herein, a “loop” refers to a sequence of instructions that is repeatedly executed until a specified condition is satisfied, while a “loop iteration” refers to one such repetition of the loop. If the instruction capacity of the fetch bundle 140 is sufficient to store more than one loop iteration, the instruction fetch circuit 110 stores one or more loop iteration copies in the fetch bundle 140 to make use of instruction capacity of the fetch bundle 140 that would otherwise go unused. In this manner, a larger number of instructions can be stored in the fetch bundle 140 and provided to subsequent stages of the instruction processing circuit 104, thus maximizing throughput.

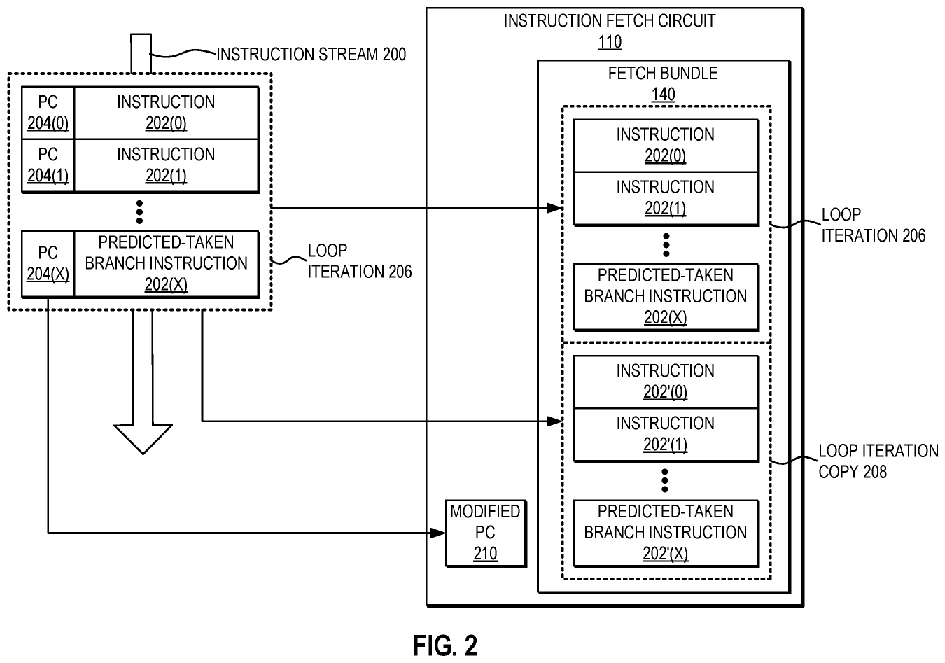

FIG. 2 illustrates exemplary functionality of the instruction fetch circuit 110 of FIG. 1 for fetching beyond predicted-taken branch instructions in fetch bundles, according to some aspects. As seen in FIG. 2, an instruction stream 200 comprising a plurality of instructions 202(0)-202(X) is being executed (e.g., by the instruction processing circuit 104 of FIG. 1), with the last instruction 202(X) being a predicted-taken branch instruction (subsequently referred to herein as the “branch instruction 202(X)” or the “predicted-taken branch instruction 202(X)”). Also shown in FIG. 2 are the instruction fetch circuit 110 and the fetch bundle 140 of FIG. 1.

The plurality of instructions 202(0)-202(X) are each associated with a corresponding PC 204(0)-204(X), and together comprise a loop iteration 206 of a loop within the instruction stream 200. Thus, in the example of FIG. 2, the branch instruction 202(X), when taken, would cause program control flow to return to the instruction 202(0), resulting in the instructions 202(0)-202(X) being executed multiple times by the instruction processing circuit 104 of FIG. 1 until some condition is met that results in the branch instruction 202(X) not being taken.

In exemplary operation, the instruction fetch circuit 110 generates the fetch bundle 140 comprising the instructions 202(0)-202(X) fetched from the instruction stream 200, with the fetch bundle 140 being associated with the PC 204(0) of the first instruction 202(0). The instruction fetch circuit 110 then determines whether the instructions 202(0)-202(X) can be identified as the loop iteration 206. In some aspects, the instruction fetch circuit 110 identifies the instructions 202(0)-202(X) as the loop iteration 206 by determining that the PC 204(0) of the fetch bundle 140 results in a hit in the BTB 138 of the instruction processing circuit 104, which indicates that the first instruction 202(0) was previously identified as the target of a branch instruction. The instruction fetch circuit 110 further determines that a target address of the predicted-taken branch instruction 202(X) corresponds to the PC 204(0) of the fetch bundle 140 (and thus the first instruction 202(0)). If both of these conditions are met, the instruction fetch circuit 110 can positively identify the instructions 202(0)-202(X) as the loop iteration 206.

The instruction fetch circuit 110 next determines whether at least one copy of the loop iteration 206 fits within the fetch bundle 140 (i.e., whether the fetch bundle 140 has sufficient available instruction capacity to store additional copies of all of the instructions 202(0)-202(X)). This may be determined by, e.g., determining whether a count of the instructions 202(0)-202(X) is equal to or less than half of the instruction capacity of the fetch bundle 140. Thus, for example, if the fetch bundle 140 can contain up to 16 instructions and the loop iteration 206 contains six (6) instructions 202(0)-202(5), the instruction fetch circuit 110 may determine that the count of the instructions 202(0)-202(5) (i.e., six (6)) is less than half of the instruction capacity of the fetch bundle 140 (i.e., eight (8)), and therefore a loop iteration copy 208 can fit within the fetch bundle 140 along with the loop iteration 206. In response to determining that the loop iteration copy 208 fits within the fetch bundle 140, the instruction fetch circuit 110 stores the loop iteration copy 208 (comprising instructions 202′(0)-202′(X), which are copies of the instructions 202(0)-202(X)) within the fetch bundle 140. It is to be understood that, while FIG. 2 shows only a single loop iteration copy 208 being stored in the fetch bundle 140, some aspects may provide that more than one loop iteration copy may be stored in the fetch bundle 140, depending on the size of each loop iteration copy and the instruction capacity of the fetch bundle 140. For instance, if the fetch bundle 140 can contain up to 16 instructions and the loop iteration 206 contains four (4) instructions, up to three (3) copies of the loop iteration 206 may be stored in the fetch bundle 140 along with the loop iteration 206.

Because the fetch bundle 140 of FIG. 2 may contain multiple branch instructions, including the predicted-taken branch instructions 202(X), 202′(X), the instruction fetch circuit 110 in some aspects provides additional functionality to enable the CBP 128 of FIG. 1 to distinguish between branch instructions in the loop iteration 206 and each loop iteration copy such as the loop iteration copy 208. For example, the CBP 128 may need to maintain different entries in the branch predictor table(s) 134 and/or the BTB 138 of FIG. 1 for the different predicted-taken branch instructions 202(X), 202′(X). Accordingly, the instruction fetch circuit 110 in some aspects generates a modified PC 210 for branch instructions within each loop iteration copy, such as the loop iteration copy 208, that may be used when accessing the CBP 128. In the example of FIG. 2, the instruction fetch circuit 110 generates a modified PC 210 for the predicted-taken branch instruction 202′(X) based on the original PC 204(X) of the branch instruction 202′(X). According to some aspects, generating the modified PC 210 may comprise the instruction fetch circuit 110 inverting one or more bits of the original PC 204(X) of the branch instruction 202′(X). The instruction fetch circuit 110 may then access the CBP 128 using the modified PC 210 of the branch instruction 202′(X) (e.g., by using the modified PC 210 of the branch instruction 202′(X) as an index and/or a tag for a branch prediction structure such as the branch prediction table(s) 134 and/or the BTB 138). Some aspects of the instruction fetch circuit 110 are configured to perform an update of the CBP 128 (e.g., by updating one or more of the history registers 136, the branch predictor table(s), and/or the BTB 138) for each of the predicted-taken branch instructions 202(X), 202′(X) within the fetch bundle 140.

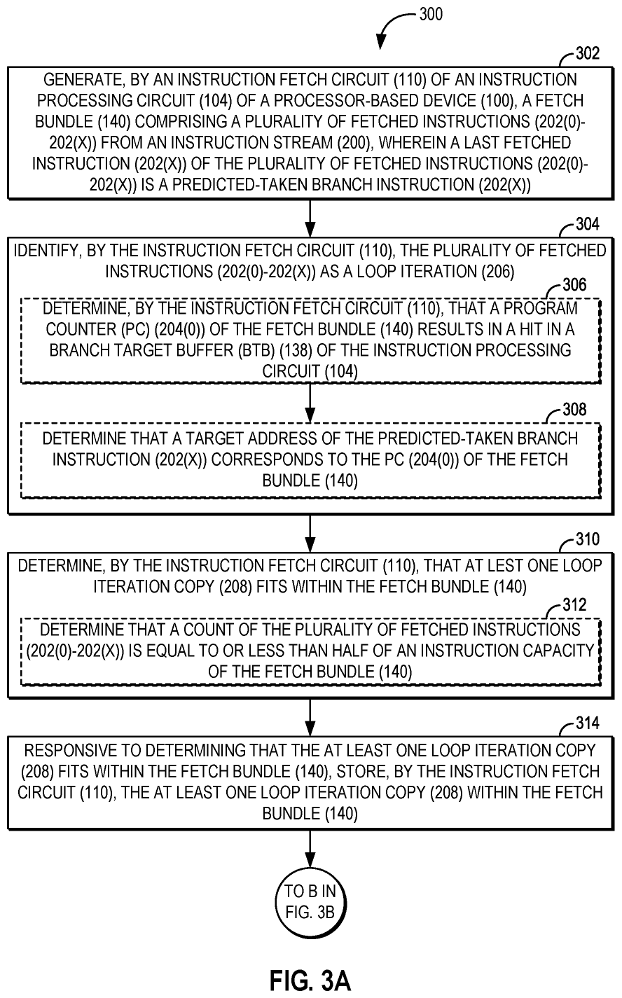

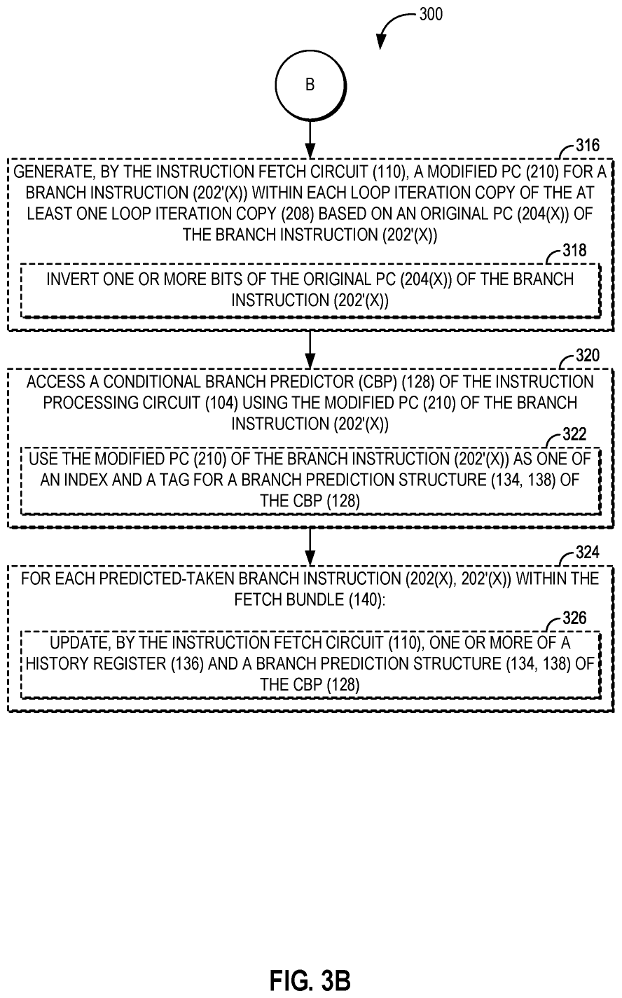

To illustrate operations performed by the instruction fetch circuit 110 of FIGS. 1 and 2 for fetching beyond predicted-taken branch instructions in fetch bundles, FIGS. 3A and 3B provide a flowchart showing exemplary operations 300. For the sake of clarity, elements of FIGS. 1 and 2 are referenced in describing FIGS. 3A and 3B. The exemplary operations 300 begin in FIG. 3A with an instruction fetch circuit (e.g., the instruction fetch circuit 110 of FIGS. 1 and 2) of an instruction processing circuit (such as the instruction processing circuit 104 of FIG. 1) of a processor-based device (e.g., the processor-based device 100 of FIG. 1) generating a fetch bundle (such as the fetch bundle 140 of FIGS. 1 and 2) comprising a plurality of fetched instructions (e.g., the instructions 202(0)-202(X) of FIG. 2) from an instruction stream (such as the instruction stream 200 of FIG. 2), wherein the last fetched instruction 202(X) of the plurality of fetched instructions 202(0)-202(X) is a predicted-taken branch instruction 202(X) (block 302). The instruction fetch circuit 110 identifies the plurality of fetched instructions 202(0)-202(X) as a loop iteration (e.g., the loop iteration 206 of FIG. 2) (block 304). In some aspects, the operations of block 304 for identifying the plurality of fetched instructions 202(0)-202(X) as the loop iteration 206 may comprise the instruction fetch circuit 110 determining that a PC of the fetch bundle 140 (e.g., the PC 204(0) of FIG. 2) results in a hit in a BTB (such as the BTB 138 of FIG. 1) of the instruction processing circuit 104 (block 306). The instruction fetch circuit 110 also determines that a target address of the predicted-taken branch instruction 202(X) corresponds to the PC 204(0) of the fetch bundle 140 (block 308).

The instruction fetch circuit 110 next determines that at least one loop iteration copy (e.g., the loop iteration copy 208 of FIG. 2) fits within the fetch bundle 140 (block 310). Some aspects may provide that the operations of block 310 for determining that the loop iteration copy 208 fits within the fetch bundle 140 comprises the instruction fetch circuit 110 determining that a count of the plurality of fetched instructions 202(0)-202(X) is equal to or less than half of an instruction capacity of the fetch bundle 140 (block 312). In response to determining that the at least one loop iteration copy 208 fits within the fetch bundle 140, the instruction fetch circuit 110 stores the at least one loop iteration copy 208 within the fetch bundle 140 (block 314). The exemplary operations 300 in some aspects may continue at block 316 of FIG. 3B.

Referring now to FIG. 3B, the instruction fetch circuit 110 in some aspects may generate a modified PC (e.g., the modified PC 210 of FIG. 2) for a branch instruction (e.g., such as the predicted-taken branch instruction 202′(X) of FIG. 2) within each loop iteration copy of the at least one loop iteration copy 208 based on an original PC (e.g., the PC 204(X) of FIG. 2) of the branch instruction 202′(X) (block 316). According to some aspects, the operations of block 316 for generating the modified PC 210 may comprise the instruction fetch circuit 110 inverting one or more bits of the original PC 204(X) of the branch instruction 202′(X) (block 318). The instruction fetch circuit 110 may then access a CBP (e.g., the CBP 128 of FIG. 1) of the instruction processing circuit 104 using the modified PC 210 of the branch instruction 202′(X) (block 320). Some aspects may provide that the operations of block 320 for accessing the CBP 128 using the modified PC 210 may comprise the instruction fetch circuit 110 using the modified PC 210 of the branch instruction 202′(X) as one of an index and a tag for a branch prediction structure (e.g., the one or more branch predictor tables 134 and/or the BTB 138 of FIG. 1) of the CBP 128 (block 322).

In some aspects, the instruction fetch circuit 110 is configured to perform operations for each predicted-taken branch instruction (such as the predicted-taken branch instructions 202(X), 202′(X) of FIG. 2) within the fetch bundle 140 (block 324). Such aspects may provide that the instruction fetch circuit 110 updates one or more of a history register (e.g., the one or more history registers 136 of FIG. 1) and a branch prediction structure (e.g., the branch predictor table(s) 134 and/or the BTB 138) of the CBP 128 (block 326).

The processor-based device according to aspects disclosed herein and discussed with reference to FIGS. 1, 2, and 3A-3B may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

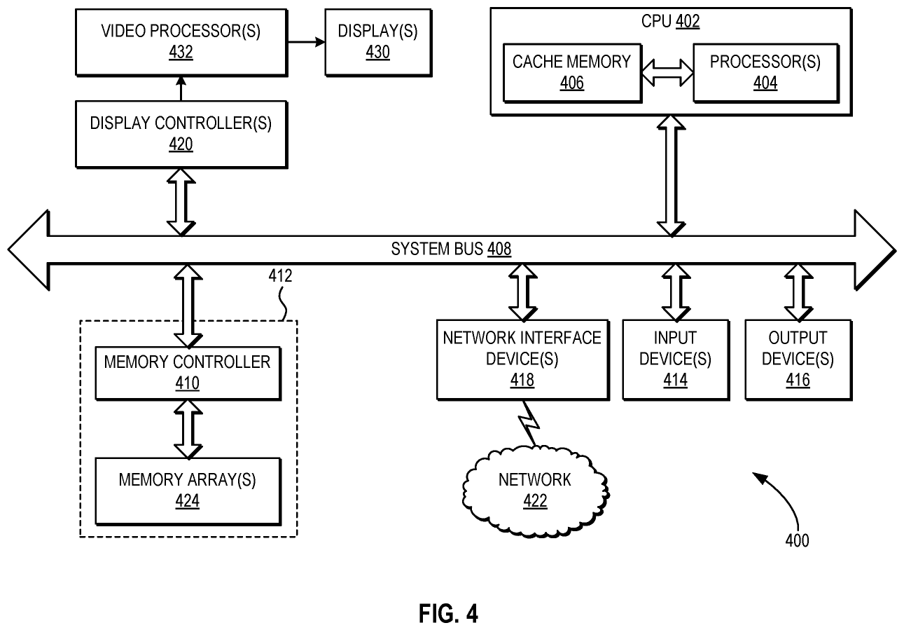

In this regard, FIG. 4 illustrates an example of a processor-based device 400 as illustrated and described with respect to FIGS. 1, 2, and 3A-3B. In this example, the processor-based device 400, which corresponds in functionality to the processor-based device 100 of FIG. 1, includes a CPU 402 which comprises one or more processors 404 coupled to a cache memory 406. The processor(s) 404 is also coupled to a system bus 408 and can intercouple devices included in the processor-based device 400. As is well known, the processor(s) 404 communicates with these other devices by exchanging address, control, and data information over the system bus 408. For example, the processor(s) 404 can communicate bus transaction requests to a memory controller 410. Although not illustrated in FIG. 4, multiple system buses 408 could be provided, wherein each system bus 408 constitutes a different fabric.

Other devices may be connected to the system bus 408. As illustrated in FIG. 4, these devices can include a memory system 412, one or more input devices 414, one or more output devices 416, one or more network interface devices 418, and one or more display controllers 420, as examples. The input device(s) 414 can include any type of input device, including, but not limited to, input keys, switches, voice processors, etc. The output device(s) 416 can include any type of output device, including, but not limited to, audio, video, other visual indicators, etc. The network interface device(s) 418 can be any devices configured to allow exchange of data to and from a network 422. The network 422 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 418 can be configured to support any type of communications protocol desired. The memory system 412 can include the memory controller 410 coupled to one or more memory arrays 424.

The processor(s) 404 may also be configured to access the display controller(s) 420 over the system bus 408 to control information sent to one or more displays 430. The display controller(s) 420 sends information to the display(s) 430 to be displayed via one or more video processors 432, which process the information to be displayed into a format suitable for the display(s) 430. The display(s) 430 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:

1. A processor-based device, comprising:
an instruction processing circuit configured to process an instruction stream in an instruction pipeline; and
the instruction processing circuit comprising an instruction fetch circuit configured to:
   generate a fetch bundle comprising a plurality of fetched instructions from the instruction stream, wherein a last fetched instruction of the plurality of fetched instructions is a predicted-taken branch instruction;
   identify the plurality of fetched instructions as a loop iteration;
   determine that at least one loop iteration copy fits within the fetch bundle; and
   responsive to determining that the at least one loop iteration copy fits within the fetch bundle, store the at least one loop iteration copy within the fetch bundle.

2. The processor-based device of clause 1, wherein:
the instruction processing circuit further comprises a branch target buffer (BTB); and
the instruction fetch circuit is configured to identify the plurality of fetched instructions as the loop iteration by being configured to:
   determine that a program counter (PC) of the fetch bundle results in a hit in the BTB; and
   determine that a target address of the predicted-taken branch instruction corresponds to the PC of the fetch bundle.

3. The processor-based device of any one of clauses 1-2, wherein the instruction fetch circuit is configured to determine that the at least one loop iteration copy fits within the fetch bundle by being configured to determine that a count of the plurality of fetched instructions is equal to or less than half of an instruction capacity of the fetch bundle.

4. The processor-based device of any one of clauses 1-3, wherein:
the instruction processing circuit further comprises a conditional branch predictor (CBP); and
the instruction fetch circuit is further configured to:
   generate a modified program counter (PC) for a branch instruction within each loop iteration copy of the at least one loop iteration copy based on an original PC of the branch instruction; and
   access the CBP using the modified PC of the branch instruction.

5. The processor-based device of clause 4, wherein the instruction fetch circuit is configured to generate the modified PC for the branch instruction by being configured to invert one or more bits of the original PC of the branch instruction.

6. The processor-based device of any one of clauses 4-5, wherein the instruction fetch circuit is configured to access the CBP using the modified PC of the branch instruction by being configured to use the modified PC of the branch instruction as one of an index and a tag for a branch prediction structure of the CBP.

7. The processor-based device of clause 6, wherein the branch prediction structure of the CBP comprises one of a branch predictor table and a branch target buffer (BTB).

8. The processor-based device of any one of clauses 4-7, wherein the instruction fetch circuit is further configured to, for each predicted-taken branch instruction within the fetch bundle, update one or more of a history register and a branch prediction structure of the CBP.

9. The processor-based device of any one of clauses 1-8, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

10. A processor-based device, comprising:
means for generating a fetch bundle comprising a plurality of fetched instructions from an instruction stream, wherein a last fetched instruction of the plurality of fetched instructions is a predicted-taken branch instruction;
means for identifying the plurality of fetched instructions as a loop iteration;
means for determining that at least one loop iteration copy fits within the fetch bundle; and
means for storing the at least one loop iteration copy within the fetch bundle, responsive to determining that the at least one loop iteration copy fits within the fetch bundle.

11. A method for fetching beyond predicted-taken branch instructions in fetch bundles, comprising:
generating, by an instruction fetch circuit of an instruction processing circuit of a processor-based device, a fetch bundle comprising a plurality of fetched instructions from an instruction stream, wherein a last fetched instruction of the plurality of fetched instructions is a predicted-taken branch instruction;
identifying, by the instruction fetch circuit, the plurality of fetched instructions as a loop iteration;
determining, by the instruction fetch circuit, that at least one loop iteration copy fits within the fetch bundle; and
responsive to determining that the at least one loop iteration copy fits within the fetch bundle, storing, by the instruction fetch circuit, the at least one loop iteration copy within the fetch bundle.

12. The method of clause 11, wherein identifying the plurality of fetched instructions as the loop iteration comprises:
determining, by the instruction fetch circuit, that a program counter (PC) of the fetch bundle results in a hit in a branch target buffer (BTB) of the instruction processing circuit; and
determining that a target address of the predicted-taken branch instruction corresponds to the PC of the fetch bundle.

13. The method of any one of clauses 11-12, wherein determining that the at least one loop iteration copy fits within the fetch bundle comprises determining that a count of the plurality of fetched instructions is equal to or less than half of an instruction capacity of the fetch bundle.

14. The method of any one of clauses 11-13, further comprising:
generating, by the instruction fetch circuit, a modified program counter (PC) for a branch instruction within each loop iteration copy of the at least one loop iteration copy based on an original PC of the branch instruction; and
accessing a conditional branch predictor (CBP) of the instruction processing circuit using the modified PC of the branch instruction.

15. The method of clause 14, wherein generating the modified PC for the branch instruction comprises inverting one or more bits of the original PC of the branch instruction.

16. The method of any one of clauses 14-15, wherein accessing the CBP using the modified PC of the branch instruction comprises using the modified PC of the branch instruction as one of an index and a tag for a branch prediction structure of the CBP.

17. The method of clause 16, wherein the branch prediction structure of the CBP comprises one of a branch predictor table and a branch target buffer (BTB).

18. The method of clause any one of clauses 14-17, further comprising, for each predicted-taken branch instruction within the fetch bundle, updating, by the instruction fetch circuit, one or more of a history register and a branch prediction structure of the CBP.

19. A non-transitory computer-readable medium, having stored thereon computer-executable instructions that, when executed, cause a processor of a processor-based device to:
generate a fetch bundle comprising a plurality of fetched instructions from an instruction stream, wherein a last fetched instruction of the plurality of fetched instructions is a predicted-taken branch instruction;
identify the plurality of fetched instructions as a loop iteration;
determine that at least one loop iteration copy fits within the fetch bundle; and
responsive to determining that the at least one loop iteration copy fits within the fetch bundle, store the at least one loop iteration copy within the fetch bundle.

20. The non-transitory computer-readable medium of clause 19, wherein the computer-executable instructions cause the processor to identify the plurality of fetched instructions as the loop iteration by causing the processor to:
determine that a program counter (PC) of the fetch bundle results in a hit in a branch target buffer (BTB) of the processor-based device; and
determine that a target address of the predicted-taken branch instruction corresponds to the PC of the fetch bundle.

21. The non-transitory computer-readable medium of any one of clauses 19-20, wherein the computer-executable instructions cause the processor to determine that the at least one loop iteration copy fits within the fetch bundle by causing the processor to determine that a count of the plurality of fetched instructions is equal to or less than half of an instruction capacity of the fetch bundle.

22. The non-transitory computer-readable medium of any one of clauses 19-21, wherein the computer-executable instructions further cause the processor to:
generate a modified program counter (PC) for a branch instruction within each loop iteration copy of the at least one loop iteration copy based on an original PC of the branch instruction; and
access a conditional branch predictor (CBP) of the processor-based device using the modified PC of the branch instruction.

23. The non-transitory computer-readable medium of clause 22, wherein the computer-executable instructions cause the processor to generate the modified PC for the branch instruction by causing the processor to invert one or more bits of the original PC of the branch instruction.

24 The non-transitory computer-readable medium of any one of clauses 22-23, wherein the computer-executable instructions cause the processor to access the CBP using the modified PC of the branch instruction by causing the processor to use the modified PC of the branch instruction as one of an index and a tag for a branch prediction structure of the CBP.

25. The non-transitory computer-readable medium of clause 24, wherein the branch prediction structure of the CBP comprises one of a branch predictor table and a branch target buffer (BTB).

26. The non-transitory computer-readable medium of any one of clauses 22-25, wherein the computer-executable instructions further cause the processor to, for each predicted-taken branch instruction within the fetch bundle, update one or more of a history register and a branch prediction structure of the CBP.

What is claimed is:

1. A processor-based device, comprising:
an instruction processing circuit configured to process an instruction stream in an instruction pipeline; and
the instruction processing circuit comprising an instruction fetch circuit configured to:
generate a fetch bundle comprising a plurality of fetched instructions from the instruction stream, wherein a last fetched instruction of the plurality of fetched instructions is a predicted-taken branch instruction;
identify the plurality of fetched instructions as a loop iteration;
determine that at least one loop iteration copy fits within the fetch bundle; and
responsive to determining that the at least one loop iteration copy fits within the fetch bundle, store the at least one loop iteration copy within the fetch bundle.

2. The processor-based device of claim 1, wherein:
the instruction processing circuit further comprises a branch target buffer (BTB); and
the instruction fetch circuit is configured to identify the plurality of fetched instructions as the loop iteration by being configured to:
determine that a program counter (PC) of the fetch bundle results in a hit in the BTB; and
determine that a target address of the predicted-taken branch instruction corresponds to the PC of the fetch bundle.

3. The processor-based device of claim 1, wherein the instruction fetch circuit is configured to determine that the at least one loop iteration copy fits within the fetch bundle by being configured to determine that a count of the plurality of fetched instructions is equal to or less than half of an instruction capacity of the fetch bundle.

4. The processor-based device of claim 1, wherein:
the instruction processing circuit further comprises a conditional branch predictor (CBP); and
the instruction fetch circuit is further configured to:
generate a modified program counter (PC) for a branch instruction within each loop iteration copy of the at least one loop iteration copy based on an original PC of the branch instruction; and
access the CBP using the modified PC of the branch instruction.

5. The processor-based device of claim 4, wherein the instruction fetch circuit is configured to generate the modified PC for the branch instruction by being configured to invert one or more bits of the original PC of the branch instruction.

6. The processor-based device of claim 4, wherein the instruction fetch circuit is configured to access the CBP using the modified PC of the branch instruction by being configured to use the modified PC of the branch instruction as one of an index and a tag for a branch prediction structure of the CBP.

7. The processor-based device of claim 6, wherein the branch prediction structure of the CBP comprises one of a branch predictor table and a branch target buffer (BTB).

8. The processor-based device of claim 4, wherein the instruction fetch circuit is further configured to, for each predicted-taken branch instruction within the fetch bundle, update one or more of a history register and a branch prediction structure of the CBP.

9. The processor-based device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

10. A processor-based device, comprising:
means for generating a fetch bundle comprising a plurality of fetched instructions from an instruction stream, wherein a last fetched instruction of the plurality of fetched instructions is a predicted-taken branch instruction;
means for identifying the plurality of fetched instructions as a loop iteration;
means for determining that at least one loop iteration copy fits within the fetch bundle; and
means for storing the at least one loop iteration copy within the fetch bundle, responsive to determining that the at least one loop iteration copy fits within the fetch bundle.

11. A method for fetching beyond predicted-taken branch instructions in fetch bundles, comprising:
generating, by an instruction fetch circuit of an instruction processing circuit of a processor-based device, a fetch bundle comprising a plurality of fetched instructions from an instruction stream, wherein a last fetched instruction of the plurality of fetched instructions is a predicted-taken branch instruction;
identifying, by the instruction fetch circuit, the plurality of fetched instructions as a loop iteration;
determining, by the instruction fetch circuit, that at least one loop iteration copy fits within the fetch bundle; and
responsive to determining that the at least one loop iteration copy fits within the fetch bundle, storing, by the instruction fetch circuit, the at least one loop iteration copy within the fetch bundle.

12. The method of claim 11, wherein identifying the plurality of fetched instructions as the loop iteration comprises:
determining, by the instruction fetch circuit, that a program counter (PC) of the fetch bundle results in a hit in a branch target buffer (BTB) of the instruction processing circuit; and
determining that a target address of the predicted-taken branch instruction corresponds to the PC of the fetch bundle.

13. The method of claim 11, wherein determining that the at least one loop iteration copy fits within the fetch bundle comprises determining that a count of the plurality of fetched instructions is equal to or less than half of an instruction capacity of the fetch bundle.

14. The method of claim 11, further comprising:
generating, by the instruction fetch circuit, a modified program counter (PC) for a branch instruction within each loop iteration copy of the at least one loop iteration copy based on an original PC of the branch instruction; and
accessing a conditional branch predictor (CBP) of the instruction processing circuit using the modified PC of the branch instruction.

15. The method of claim 14, wherein generating the modified PC for the branch instruction comprises inverting one or more bits of the original PC of the branch instruction.

16. The method of claim 14, wherein accessing the CBP using the modified PC of the branch instruction comprises using the modified PC of the branch instruction as one of an index and a tag for a branch prediction structure of the CBP.

17. The method of claim 16, wherein the branch prediction structure of the CBP comprises one of a branch predictor table and a branch target buffer (BTB).

18. The method of claim 14, further comprising, for each predicted-taken branch instruction within the fetch bundle, updating, by the instruction fetch circuit, one or more of a history register and a branch prediction structure of the CBP.

19. A non-transitory computer-readable medium, having stored thereon computer-executable instructions that, when executed, cause a processor of a processor-based device to:
generate a fetch bundle comprising a plurality of fetched instructions from an instruction stream, wherein a last fetched instruction of the plurality of fetched instructions is a predicted-taken branch instruction;
identify the plurality of fetched instructions as a loop iteration;
determine that at least one loop iteration copy fits within the fetch bundle; and
responsive to determining that the at least one loop iteration copy fits within the fetch bundle, store the at least one loop iteration copy within the fetch bundle.

20. The non-transitory computer-readable medium of claim 19, wherein the computer-executable instructions cause the processor to identify the plurality of fetched instructions as the loop iteration by causing the processor to:
determine that a program counter (PC) of the fetch bundle results in a hit in a branch target buffer (BTB) of the processor-based device; and
determine that a target address of the predicted-taken branch instruction corresponds to the PC of the fetch bundle.

21. The non-transitory computer-readable medium of claim 19, wherein the computer-executable instructions cause the processor to determine that the at least one loop iteration copy fits within the fetch bundle by causing the processor to determine that a count of the plurality of fetched instructions is equal to or less than half of an instruction capacity of the fetch bundle.

22. The non-transitory computer-readable medium of claim 19, wherein the computer-executable instructions further cause the processor to:
generate a modified program counter (PC) for a branch instruction within each loop iteration copy of the at least one loop iteration copy based on an original PC of the branch instruction; and
access a conditional branch predictor (CBP) of the processor-based device using the modified PC of the branch instruction.

23. The non-transitory computer-readable medium of claim 22, wherein the computer-executable instructions cause the processor to generate the modified PC for the branch instruction by causing the processor to invert one or more bits of the original PC of the branch instruction.

24. The non-transitory computer-readable medium of claim 22, wherein the computer-executable instructions cause the processor to access the CBP using the modified PC of the branch instruction by causing the processor to use the modified PC of the branch instruction as one of an index and a tag for a branch prediction structure of the CBP.

25. The non-transitory computer-readable medium of claim 24, wherein the branch prediction structure of the CBP comprises one of a branch predictor table and a branch target buffer (BTB).

26. The non-transitory computer-readable medium of claim 22, wherein the computer-executable instructions further cause the processor to, for each predicted-taken branch instruction within the fetch bundle, update one or more of a history register and a branch prediction structure of the CBP.
